(19) United States
(12) Patent Application Publication
(10) Pub. No.: US 2016/0257352 A1
(43) Pub. Date: Sep. 8, 2016

(54) TRACTOR CAB AIR RIDE SYSTEM WITH LADDER PRESERVATION

(71) Applicant: Nicholas L. Colbert, Davenport, WA (US)

(72) Inventor: Nicholas L. Colbert, Davenport, WA (US)

(21) Appl. No.: 15/063,504

(22) Filed: Mar. 7, 2016

Related U.S. Application Data
(60) Provisional application No. 62/129,614, filed on Mar. 6, 2015.

(51) Int. Cl. B62D 33/10; B62D 65/02

(52) U.S. Cl. CPC B62D 33/10; B62D 65/02

(57) ABSTRACT

An air ride suspension kit for a track style articulating-type tractor. The kit comprises one or more support beams, air bags, shock absorbers, stabilizer bars and related hardware. Automatically controlled ladder on the original factory tractor can be preserved. Methods and products resulting from the methods pertaining to the disclosed apparatus are provided.

This application claims the benefit of U.S. Provisional Application No. 62/129,614, filed Mar. 6, 2015, and whose entire contents are hereby incorporated by reference.

### FIELD OF ART

Embodiments of invention disclosed herein relate to an air ride suspension system or kit for articulating agricultural tractors. The air ride kit significantly reduces stress and fatigue of the tractor operator. In comparison to prior art, the disclosed air ride kit preserves the ladder on the articulating tractor, which serves as a substantial safety feature and necessary item for accessibility to the tractor cab. More specifically, the invention relates to a combination of one or more air bags, shock absorbers, metal structure and hardware installed strategically under an articulating-type tractor cab.

### BACKGROUND

Farmers are known to work from sunrise to sundown, and most modern farmers spend a great deal of time in the cab of a modern articulating tractor. Modern tractors are typically reasonably heavy vehicles with stiff suspensions and stiff springs, resulting in a jarring ride during operation. Although the cab of a modern tractor is a separate module from the chassis of the tractor, the two components are frequently secured to one another through hardware (e.g. bolts & nuts), and sometimes rubber bushings. However, the bushings are typically too stiff to absorb the jarring motions of the tractor during operation.

It is unfortunate that the farmer or tractor operator experiences so much fatigue and discomfort due to lack of a support system between the tractor cab and frame. This discomfort causes extra unnecessary frustration and stress to the body due to constant jarring movement while the tractor is in motion. Because of this reoccurring motion the driver is more prone to accidents, fatigue and health related issues when operated.

To overcome such a jarring ride, particularly over long periods of time, it is not uncommon to equip a tractor with an air ride suspension. Prior art evidences aftermarket kits available to upgrade tractors to air suspension, but such kits typically use highway truck tractor kits (e.g. semi truck air ride kits) to attempt to solve the problem. These kits are not designed nor conducive to the designs of articulating tractors.

Much less, prior art solutions require either modification or removal of the ladder, which is a necessary safety feature. In articulating tractors, when the tractor is turned (e.g. turned sharp left), the ladder also moves so that it avoids contact with the treads of the front/rear portions of the tractor. However, when modified, such air ride solutions necessitate that the moving ladder be made stationary or removed altogether. When the ladder is modified to avoid contact with the treads or other moving parts of the tractor, this results in either: the tires of the tractor hit the ladder, the ladder is at an undesirable ladder/position, or the ladder sticks out of the tractor at a very undesirable angle and increases the vehicle width (e.g. upward and out). In the last situation, the tractor suddenly becomes an “overwidth” vehicle and requires a special permit to be driven or transported, even on rural roads between fields.

Modification or removal of the ladder results in unsafe hazards being introduced to an already hazardous profession driving a tractor. First, it poses a problem to the tractor driver by not having a safe ladder to enter in and egress/exit out of the tractor properly. Second, as noted above, a ladder sticking out the (typically left) side of the tractor requires a special permit, and possibly flaggers and lead/trail vehicles—simply to transport the modified tractor.

Third, when parking the tractor in a storage facility, accidents are more likely to occur with the storage structure as well as other tractors or nearby equipment due to the ladder sticking out. Since the ladder in such scenarios is now in a fixed position and does not articulate with the movement of the tractor, many tasks become more difficult and dangerous.

Fourth, while working in the fields, a non-standard ladder sticking out the side of the tractor can also cause crop disturbance. Namely, it can slash the standing crop lowering harvest yields.

Lastly, the unsafe ladder angle, whether due to crops, safety, egress or other reasons, becomes a constant distraction placing extra unnecessary stress on the tractor operator. Whether operating, hauling, parking, turning, entering or exiting the tractor, new unsafe conditions are created that would otherwise be handled safely with a functional ladder being preserved.

Thus, there exists a need for an aftermarket solution for a kit to provide air ride suspension in an articulating-type tractor, further preserving the safety and benefits of an operable ladder. Such an air ride kit preferably maintains both the manufacturer operating ladder and rollover cab protection specifications. The present invention fills this need, as will be understood from the following description and accompanying drawings.

### SUMMARY

In one aspect, embodiments of the present invention provide an air ride suspension for non air ride articulating-type tractors, providing increased levels of comfort and safety when operating such machinery. Among the benefits rendered are a more comfortable ride, a functional ladder, reduced fatigue and stress for the driver, reduced likelihood of special permits or other costs to transport the tractor. Embodiments typically comprise an air bag system to act as a suspension between the cab and the chassis of a tractor, one or more shock absorbers to dampen vertical movement between the cab and the chassis, one or more stabilizer bars to eliminate horizontal travel between the cab and chassis, and other attachment hardware or other parts.

In a second aspect, this air ride suspension system or kit provides the ability to maintain the automatically controlled ladder of a track-type articulating tractor (e.g. a Case STX series tractor and other tractors). In other prior art solutions, the automatic controls of the ladder must be removed from the tractor as other prior art solutions have a spacial interference or conflict with the automatic controls of the ladder. However, when using the apparatus and methods described herein, the automatic controlled ladder can remain operation on the tractor.

In another aspect, installation of the air ride suspension kit is described. Namely, the tractor is disassembled for safety and access to the underside of the cab, followed by attachment of various parts of the air ride suspension kit to the cab and the chassis, followed by re-assembly of the tractor to its operational state. More particularly, the air bags are sandwiched between two horizontal beams, an upper beam coupled to the cab of the tractor providing an upper communication point for the air bag(s), as well as an upper attachment point for the shock absorbers and an attachment point for the stabilizer bar. A lower horizontal bar serves as a platform for the air bag(s), as well as a lower attachment point for the shock absorbers and other parts. The air ride suspension kit typically but not exclusively utilizes original equipment manufacturer (OEM) cab mounting bolts and bushings, which are temporarily removed for installation of the kit. Special spacing shims are provided to provide an exact position for the lower horizontal beam to be secured to the chassis. Securing the horizontal beams to the cab and chassis, respectively, can be accomplished by any conventional securing means such as hardware (e.g. bolts and nuts), affixing (e.g. welding) or other conventional attachment means. In preferred embodiments, the horizontal beams are welded to the cab and chassis, respectfully.

In yet another aspect, an air ride suspension cab articulating-type tractor can be produced when the steps of the methods described are performed on an articulating-type tractor. The air ride cab solution and method thereof has been made compact and fits genuinely between the tractor cab and chassis. In preferred embodiments, the resulting product has the durability to endure and soften the tractor cab jarring movement. In preferred embodiments, if further blends nicely with the tractor giving the invention a factory appearance. The resulting product retains automatic control of the ladder and thus maintains the safety of the OEM design. It is clear that this unique apparatus and method results in enhancements for entering, exiting, moving, hauling and parking such an articulated-type tractor.

Other embodiments, and other features and objects of the present invention will be in part apparent to those skilled in the art and in part pointed out hereinafter.

### BRIEF DESCRIPTION OF THE DRAWINGS

Embodiments of the invention are illustrated by way of example, and not by way of limitation, in the figures of the accompanying drawings and in which like reference numerals refer to similar elements, wherein:

FIG. 1 is a cutaway rear view of a cab and a chassis of a prior art articulating-type tractor.

FIG. 2 is a top view of a prior art articulating-type tractor comprising an automatically controlled ladder.

FIG. 3 is a cutaway rear view of an embodiment of the invention, namely an air ride suspension articulating-type tractor.

FIG. 4 is a flowchart illustrating the method of installing an air ride suspension kit on an articulating-type tractor.

### DETAILED DESCRIPTION OF PREFERRED EMBODIMENTS

In the following description, for the purposes of explanation, specific details are set forth in order to provide a thorough understanding of the invention. However, it will be apparent that the invention may be practiced without these specific details. In other instances, well-known structures and devices may be depicted in block diagram form or simplified form in order to avoid unnecessary obscuring of the invention. Section titles and references appearing within the following paragraphs are intended for the convenience of the reader and should not be interpreted to restrict the scope of the information presented at any given location. As such, various aspects and features of example embodiments of the invention are described in more detail hereinafter in the following sections.

The present disclosure describes apparatus and methods to convert a typical (non air ride) articulating tractor into an air ride suspension articulating tractor. Typically, tractors (and particularly tractors having tracks rather than wheels/tires for locomotion) do not have air suspension for the cab portion of the tractor. Most OEM tractors have the cab hard coupled to the chassis of the tractor through various connections means such as hardware (e.g. bolts and nuts). Some tractors utilize rubber bushings, but such bushings are typically stiff and do not provide any substantial suspension benefits.

### Apparatus

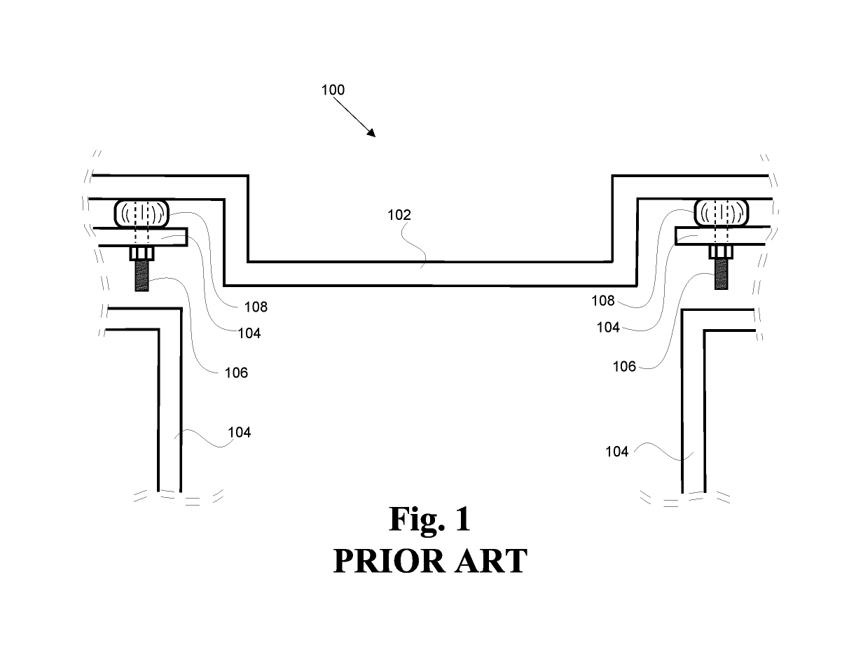

FIG. 1 illustrates a cutaway view from the rear of a prior art tractor 100. The tractor 100 comprises at a top level a cab 102 where the driver operates the vehicle and a chassis 104 acting as a frame or framework for the various functional components of the tractor (e.g. engine, transmission, axles, etc.).

From the manufacturer, the cab 102 is coupled to the chassis 104 using one or more cab mounting bolts 106, typically with a bushing 108 provided between the cab 102 and the chassis 104.

Typically, a one or more studs 110 protrude beneath the cab 102 floor into space below the cab 102. The one or more studs 110 serve no purpose but are left as a result of the manufacturing process of the cab 102 by the original manufacturer of the tractor 100.

The ride and operation of said tractor 100 can be rather harsh and jarring, as a bushing 108 does not provide any substantial shock or vibration absorption, nor suspension, between the cab 102 and the chassis 104.

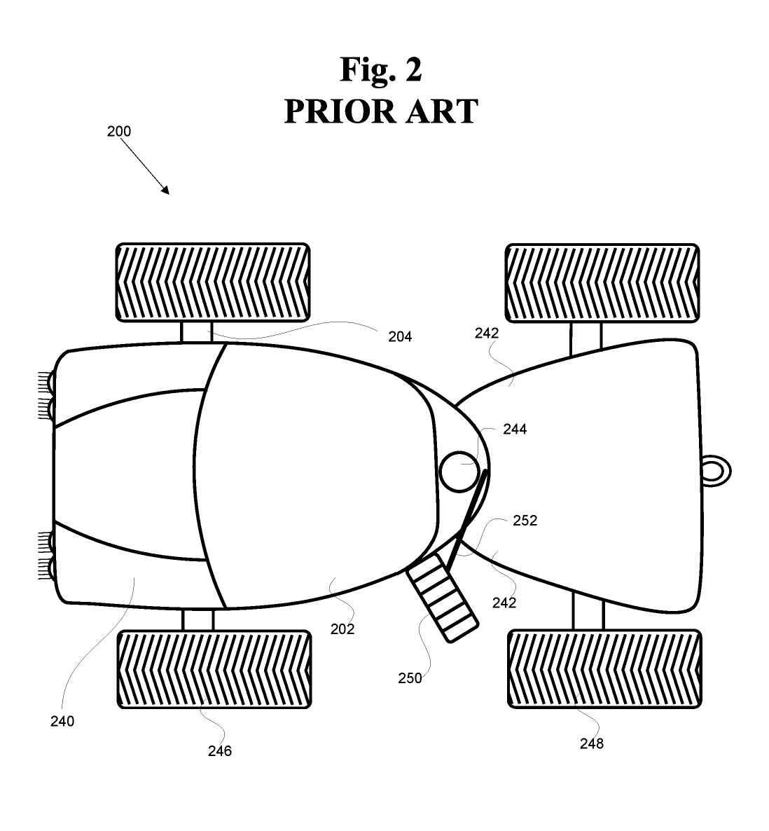

Turning to FIG. 2, a similar prior art track style articulating-type tractor 200 is illustrated. The tractor 200 comprises a front end 240 and a rear end 242, a cab 202 and a chassis 204.

Prior art tractor 200 further comprises of an automatically controlled ladder 250 and an automatic ladder control means 252. Typically, the automatic ladder control means 252 is a swingarm and related hardware that spans from the ladder on the left side of the tractor 202 to a location proximate to a pivot point 244 of the tractor, typically occupying space beneath the cab 202 and above or about the chassis 204.

When the tractor 200 articulates to turn left (not illustrated), a left front track 246 becomes proximately closer to a left rear track 248. In extreme situations of a sharp left turn, there is not much room between the front left track 246 and the rear left track 248, so the automatically controlled ladder 250 precisely avoids contact with either of the tracks 246 and 248 by positioning the ladder at an angle horizontally and vertically where the interference is minimized. However, this becomes very problematic with prior art air ride suspension kits.

Although prior art air ride suspension kits are available, typically based on air ride systems for highway truck tractors, such prior art suspension kits require the space occupied by either the ladder 250 or ladder control means 252, or both. Thus, when such prior art kits are configured on a prior art tractor 200 as illustrated, the ladder 250 must be either fixed statically to the tractor 200 (resulting in significant spacial conflict between the ladder 250 and the tracks 246 and 248, or an undesirable angle for the ladder to stick out away from the tractor 200). Alternatively, the ladder 250 must be removed from the tractor 200 which is even more undesirable for convenience and safety reasons.

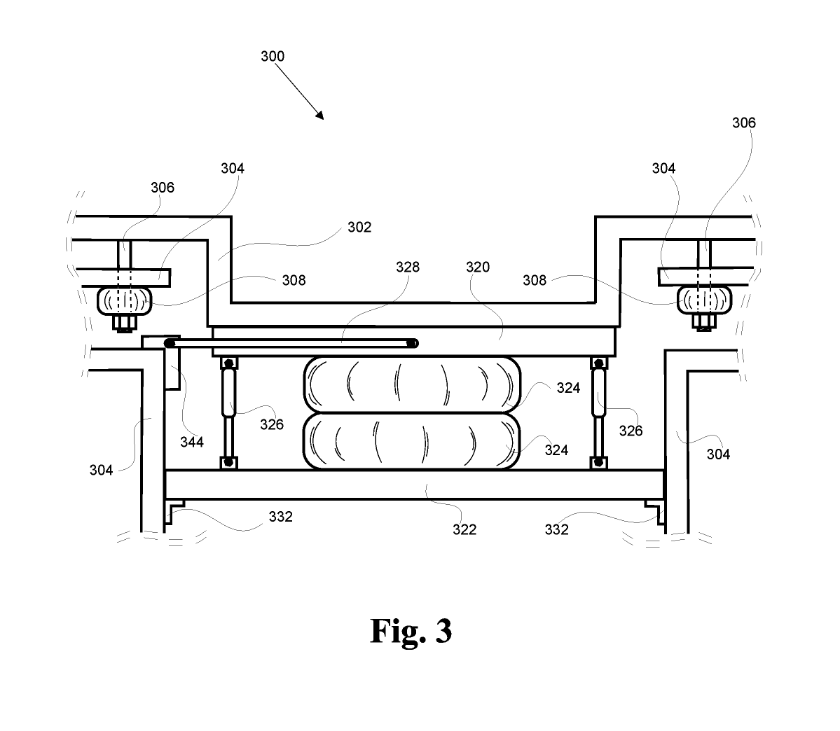

Turning to FIG. 3, a cutaway rear view of an embodiment of the invention is illustrated, namely a tractor 300. The tractor 300 comprises at a top level a cab 302 where the driver operates the vehicle and a chassis 304 acting as a frame or framework for the various functional components of the tractor (e.g. engine, transmission, axles, etc.).

While the cab 302 is still coupled to the chassis 304 using one or more cab mounting bolts 306, and a one or more bushings 308, the tractor 300 comprises air ride suspension through various components, namely: an upper horizontal beam 320, a lower horizontal beam 322, a one or more airbags 324, a one or more shock absorbers 326, a stabilizer bar 328, a stabilizer bar bracket 330 and a one or more beam brackets 332.

More particularly, the upper horizontal beam 320 provides a coupling between the cab 302 and various other components, such as the shock absorbers 326, stabilizer bar 328, as well as a suspension or pressure point for the top of the air bags 324. In preferred embodiments, the upper horizontal beam 320 is welded to the chassis 304 for maximum strength.

Similarly, the lower horizontal beam 322 provides a coupling between the chassis 304 and various components, such as the shock absorbers 326 and the airbags 324. In preferred embodiments, the lower horizontal beam 322 is welded to the chassis 304 for maximum strength.

The air bags 324 are configured to withstand the forces generated by the weight and dynamics of cab 302 during typical tractor 300 operation. Preferably the air bags 324 are configured with specific compressible gas and pressure properties set for the desired softness and ride of the tractor 300. It is preferable not to use gas lines, gas compressors or other additional hardware or equipment with the air bags that could fail during operation, although many prior art embodiments typically use such vulnerable equipment subject to failure.

The shock absorbers 326 are configured to a length and stiffness commensurate with the operating requirements of the tractor 300. Such shock absorbers 326 can be gas or fluid filled, with fixed or adjustable valves. Typically, the shock absorbers 326 are coupled to the upper horizontal beam 320 and lower horizontal beam 322 with conventional hardware, providing for ease of maintenance and replacement.

The stabilizing bar 328, as illustrated, reduces or eliminates undesirable horizontal movement relative between the cab 302 and the chassis 304. The stabilizing bar 328 is preferably coupled using conventional hardware to the stabilizing bar bracket 330, which is in turn coupled to the chassis 304 (preferably welded to the chassis 304). The other end of the stabilizing bar 328 is coupled to the upper horizontal beam 320 also by conventional hardware, thereby providing that the stabilizer bar 328 can swivel at each end as the cab 302 changes its position with respect to the chassis 304.

In preferred embodiments, one or more beam brackets 332 are welded to the chassis 304, providing that the lower horizontal beam 322 cannot detach nor slip downward on the chassis 304.

In preferred embodiments, a one or more cab mounting bolts and a one or more bushings 308 are utilized as illustrated to provide a slidable coupling between the cab 302 and the chassis 304.

It is inherent and a key point in the present embodiments that the above components do not interfere with the ladder control means (not shown), such that the automatically controlled ladder (not shown) can be maintained as originally provided on the tractor 300. It is through the design of the components above, as well as the reduced footprint of the air bags 324 and other components, that this can be achieved in the present embodiments.

### Installation

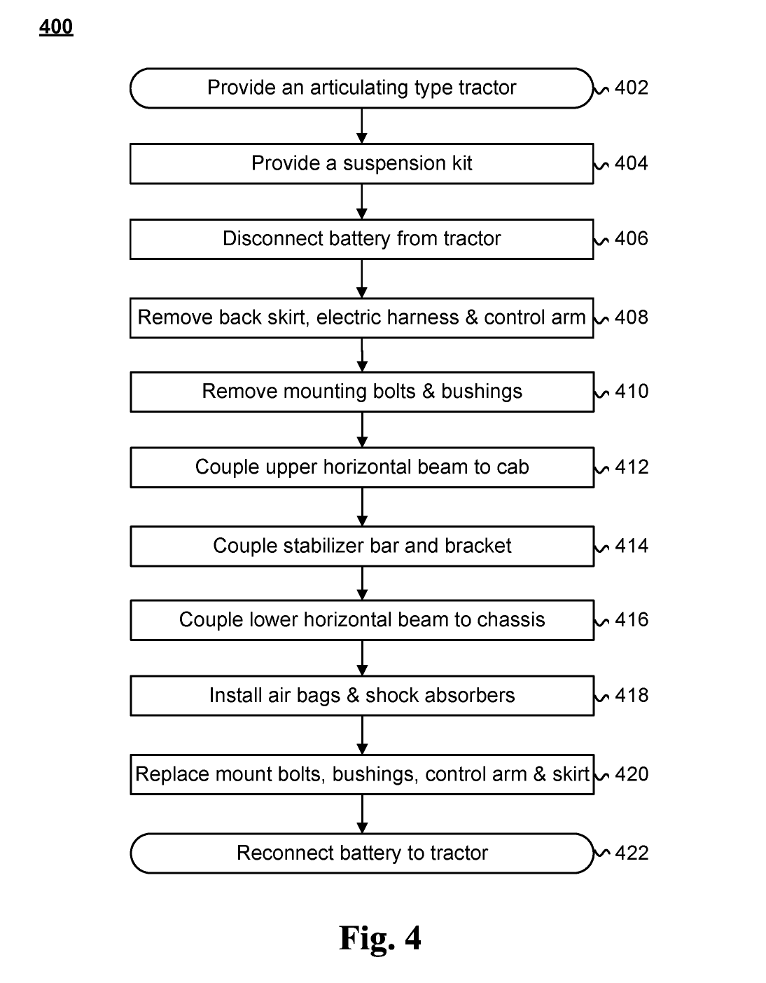

Turning to FIG. 4, a flowchart 400 illustrates the steps of installation of an embodiment of the present invention.

More particularly, step 402 provides an articulating type tractor, the tractor further comprising a cab and a chassis, a front end and a rear end, an automatically controlled ladder situated between the front end and the rear end, a battery comprising a plurality of battery terminals connected to the tractor, a back skirt, a ladder control arm controlling the automatically controlled ladder, a plurality of cab mounting bolts, a cab air filter box, a cab air filter hose, an electrical harness, an electrical harness mount and a plurality of studs beneath the cab.

Step 404 provides an air ride suspension kit, the kit further comprising an upper horizontal beam, a lower horizontal beam, an air bag, a shock absorber, a stabilizer bar, a stabilizer bar bracket, a plurality of shims, a quantity of paint and a quantity of compressible gas for the air bag.

Details of the collective components above are further discussed in conjunction with the installation step(s) affecting said components.

In step 406, the battery is electrically disconnected from the tractor by disconnecting the battery terminals (e.g. removing battery cables from the battery terminals).

In step 408, the back skirt of the tractor is removed, thereby exposing the underside of the cab and the chassis of the tractor. The electrical harness is also disconnected and removed, followed by removal of the electrical harness mount. Lastly, the ladder control arm is removed, providing ample room to install the kit underneath the cab and within the chassis of the tractor.

In step 410, the cab mounting bolts and bushings are removed, thereby allowing the cab to be able to be mechanically moved upward or downward and side to side relative to the chassis.

In step 412, the upper horizontal beam is fixably coupled to the bottom side of the cab. As necessary, the studs on the underside of the cab are ground off and removed. Preferably, such a coupling of the upper horizontal beam to the cab is by welding, but can also be accomplished by other conventional attachment means (e.g. hardware).

In step 414, the stabilizer bar bracket is fixably attached to the chassis. Again, in preferred embodiments this is by weld, although conventional attachment means (e.g. hardware) can also be used. Once affixed, the stabilizer bar is coupled to the stabilizer bar bracket on one end, and coupled to the upper horizontal beam on the other end. Preferably, this coupling is accomplished with conventional attachment means such as bolts and nuts.

In step 416, the lower horizontal beam is positioned within the chassis using special length shims to hold the lower horizontal beam while it is coupled to the chassis. In preferred embodiments, the lower horizontal beam is coupled to the chassis utilizing welding. It is further preferable to install (and preferably weld) beam brackets below each side of the lower horizontal beam to further increase the strength of the coupling between the upper horizontal beam and the chassis on each side.

In step 418, the air bag is installed and sandwiched between the upper horizontal beam and the lower horizontal beam, using conventional attachment means (e.g. hardware, adhesives, etc.). The air bags can be filled using a quantity of compressible gas provided earlier, at a pressure desired for a particular softness of the suspension. The shock absorber is installed and coupled both the upper horizontal beam 318 (in FIG. 3) and lower horizontal beam 320 (in FIG. 3), preferably using conventional attachment means (e.g. bolts and nuts) so that maintenance and replacement is convenient.

It is further preferable before proceeding to paint any exposed bare metal surfaces caused by grinding, welding or other installation steps using the quantity of paint provided earlier.

In step 420, the cab mounting bolts are replaced, providing a slidable coupling between the cab and chassis. More particularly, the bushing (as originally removed from its original position above the chassis) is placed beneath the chassis but secured by the cab mounting bolts/nuts to provide rollover protection. Similarly, the ladder control arm, electrical harness and back skirt of the tractor is replaced.

In step 422, the process is complete when the battery is reconnected to the tractor at the battery terminals.

It is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

### ALTERNATE EMBODIMENTS & CONCLUSION

There are numerous and diverse additional embodiments anticipated by the present invention, as further summarized below. Therefore, it is further understood that the following examples are not limiting by nature, but rather alternate specific examples where the disclosed apparatus and method can be utilized.

The novel and useful approaches described herein evidence a variety of benefits over prior art approaches. In particular, embodiments of the present invention provide one or more additional aspects of enhanced convenience, usability and reliability over the prior art.

Preferred embodiments of this invention are described herein, including the best mode known to the inventors for carrying out the invention. As can be appreciated from the technical disclosure herein, embodiments of the present invention evidence a variety of advances and benefits over the prior art, uniquely and advantageously yielding savings of time, effort, and cost relative to the existing prior art currently utilized. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention. Groupings of alternative elements or embodiments of the invention disclosed herein are not to be construed as limitations. Each group member may be referred to and claimed individually or in any combination with other members of the group or other elements found herein.

Furthermore, if any references have been made to patents and printed publications in this specification, then each of the above cited references and printed publications, if any, are herein individually incorporated by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The invention claimed is:

1. An apparatus for air ride suspension between a cab and a chassis of an articulating-type tractor, the articulating-type tractor comprising a front end, a rear end, and an automatically controlled ladder situated between the front end and the rear end, wherein the apparatus comprises:
an upper horizontal beam coupled to the bottom of the cab;
a lower horizontal beam coupled to the chassis;
an air bag communicating with the upper horizontal beam and the lower horizontal beam, thereby providing mechanical pressure between the cab and the chassis;
a shock absorber coupled to the upper horizontal beam and the lower horizontal beam, thereby dampening vertical movement relative to the cab and the chassis;
a stabilizing arm coupled to the upper horizontal beam and the chassis, thereby preventing the cab from shifting horizontally relative to the chassis; and,
wherein the air bag does not interfere with movement or operation of the ladder.

2. The air ride suspension apparatus of claim 1, wherein:
the articulating-type tractor comprises a plurality of tracks rather than wheels for locomotion.

3. The air ride suspension apparatus of claim 1, wherein:
the upper horizontal beam is welded to the cab.

4. The air ride suspension apparatus of claim 1, wherein:
the lower horizontal beam is welded to the chassis.

5. The air ride suspension apparatus of claim 1, wherein:
the air bag is a plurality of air bags.

6. The air ride suspension apparatus of claim 1, wherein:
the shock absorber comprises a plurality of shock absorbers coupled to the upper horizontal beam and the lower horizontal beam.

7. The air ride suspension apparatus of claim 1, wherein:
the stabilizing arm further comprises a stabilizing arm bracket, wherein the stabilizing arm bracket is coupled to the stabilizer arm and the chassis.

8. The air ride suspension apparatus of claim 1, wherein:
the articulating-type tractor comprises a plurality of tracks rather than wheels for locomotion;
the upper horizontal beam is welded to the cab;
the lower horizontal beam is welded to the chassis;
the air bag is a plurality of air bags;
the shock absorber comprises a plurality of shock absorbers coupled to the cab and the horizontal support beam; and,
the stabilizing arm comprises a stabilizing arm bracket, wherein the stabilizing arm bracket is coupled to the stabilizer arm and the chassis.

9. A method for installing air ride suspension, wherein the method comprises the steps of:
providing an articulating-type tractor, wherein the tractor comprises a cab, a chassis, a front end, a rear end, an automatically controlled ladder situated between the front end and the rear end, a battery wherein the battery comprising a plurality of battery terminals connected to the tractor, a back skirt, a ladder control arm controlling the automatically controlled ladder and a plurality of cab mounting bolts;
providing an air ride suspension kit, the air ride suspension kit comprising an upper horizontal beam, a lower horizontal beam, an air bag, a stabilizer bar, a stabilizer bar bracket, a shock absorber and a plurality of shims;
disconnecting the plurality of battery terminals from the tractor;
removing the back skirt from the tractor;
removing the ladder control arm;
removing the plurality of cab mounting bolts;
securing the upper horizontal beam to the cab;
securing the stabilizer bar bracket to the chassis;
securing the stabilizer bar to the stabilizer bar bracket and the upper horizontal beam;
positioning the plurality of shims beneath the lower horizontal beam to hold the horizontal beam in a desirable position relative to the upper horizontal beam and chassis;
securing the lower horizontal beam to the chassis;
securing the air bag to the lower horizontal beam;
securing the shock absorber to the upper horizontal beam and the lower horizontal beam;
replacing at least a portion of the plurality of cab mounting bolts;
replacing the ladder control arm;
replacing the back skirt on the tractor; and,
reconnecting the plurality of battery terminals to the tractor.

10. The method of installing air ride suspension of claim 9, wherein:
the step of securing the upper horizontal beam to the cab comprises welding the upper horizontal beam to the cab;
the step of securing the lower horizontal beam to the chassis comprises welding the lower horizontal beam to the cab; and,
the step of securing the stabilizer bar bracket to the chassis comprises welding the stabilizer bar bracket to the chassis.

11. The method of installing air ride suspension of claim 9, wherein:
the shock absorber comprises a plurality of shock absorbers.

12. The method of installing air ride suspension of claim 9, wherein:
the step of providing an articulating-type tractor further comprises the tractor further comprising a cab air filter box, a cab air filter hose, an electrical harness, an electrical harness mount and a plurality of studs beneath the cab;
and, wherein the method of installing air ride suspension further comprises the steps of:
removing the cab air filter box and the cab air filter hose;
disconnecting the electrical harness;
removing the electrical harness mounting bracket;
grinding down the plurality of studs beneath the cab prior to securing the upper horizontal beam;
grinding paint from the cab and the chassis at locations where welding will occur;
replacing the cab air filter box and the cab air filter hose; and
reconnecting the electrical harness.

13. The method of installing air ride suspension of claim 9, wherein:
the step of providing an air ride suspension kit further comprises providing a quantity of paint and a quantity of compressible gas;
and, wherein the method of installing air ride suspension further comprises the steps of:
adding the quantity of compressible gas to the air bag; and,
applying the quantity of paint to welded metal and ground metal resulting from the previous steps.

14. The method of installing air ride suspension of claim 9, further comprising the step of:
raising the cab from the chassis after the step of removing the plurality of cab mounting bolts; and
lowering the cab onto the airbags before the step of replacing at least a portion of the plurality of cab mounting bolts.

15. An air ride suspension tractor, the product of the process of:
providing an articulating-type tractor, wherein the tractor comprises a cab, a chassis, a front end, a rear end, an automatically controlled ladder situated between the front end and the rear end, a battery wherein the battery comprising a plurality of battery terminals connected to the tractor, a back skirt, a ladder control arm controlling the automatically controlled ladder and a plurality of cab mounting bolts;
providing an air ride suspension kit, the air ride suspension kit comprising an upper horizontal beam, a lower horizontal beam, an air bag, a stabilizer bar, a stabilizer bar bracket, a shock absorber and a plurality of shims;
disconnecting the plurality of battery terminals from the tractor;
removing the back skirt from the tractor;
removing the ladder control arm;
removing the plurality of cab mounting bolts;
securing the upper horizontal beam to the cab;
securing the stabilizer bar bracket to the chassis;
securing the stabilizer bar to the stabilizer bar bracket and the upper horizontal beam;
positioning the plurality of shims beneath the lower horizontal beam to hold the horizontal beam in a desirable position relative to the upper horizontal beam and chassis;
securing the lower horizontal beam to the chassis;
securing the air bag to the lower horizontal beam;
securing the shock absorber to the upper horizontal beam and the lower horizontal beam;
replacing at least a portion of the plurality of cab mounting bolts;
replacing the ladder control arm;
replacing the back skirt on the tractor; and,
reconnecting the plurality of battery terminals to the tractor.

16. The method of installing air ride suspension of claim 15, wherein:
the step of securing the upper horizontal beam to the cab comprises welding the upper horizontal beam to the cab;
the step of securing the lower horizontal beam to the chassis comprises welding the lower horizontal beam to the cab; and,
the step of securing the stabilizer bar bracket to the chassis comprises welding the stabilizer bar bracket to the chassis.

17. The method of installing air ride suspension of claim 15, wherein:
the shock absorber comprises a plurality of shock absorbers.

18. The method of installing air ride suspension of claim 15, wherein:
the step of providing an articulating-type tractor further comprises the tractor further comprising a cab air filter box, a cab air filter hose, an electrical harness, an electrical harness mount and a plurality of studs beneath the cab;
and, wherein the method of installing air ride suspension further comprises the steps of:
removing the cab air filter box and the cab air filter hose;
disconnecting the electrical harness;
removing the electrical harness mounting bracket;
grinding down the plurality of studs beneath the cab prior to securing the upper horizontal beam;
grinding paint from the cab and the chassis at locations where welding will occur;
replacing the cab air filter box and the cab air filter hose; and
reconnecting the electrical harness.

19. The method of installing air ride suspension of claim 18, wherein:
the step of providing an air ride suspension kit further comprises providing a quantity of paint and a quantity of compressible gas;
and, wherein the method of installing air ride suspension further comprises the steps of:
adding the quantity of compressible gas to the air bag; and,
applying the quantity of paint to welded metal and ground metal resulting from the previous steps.

20. The method of installing air ride suspension of claim 19, further comprising the step of:
raising the cab from the chassis after the step of removing the plurality of cab mounting bolts; and
lowering the cab onto the airbags before the step of replacing at least a portion of the plurality of cab mounting bolts.
